(19) United States
(12) Patent Application Publication
(10) Pub. No.: US 2025/0037063 A1
(43) Pub. Date: Jan. 30, 2025

(54) System and Method for Preventing Human Errors

(71) Applicant: Lizandra Bernier-Rivera, Guayama, PR (US)

(72) Inventor: Lizandra Bernier-Rivera, Guayama, PR (US)

(21) Appl. No.: 18/912,295

(22) Filed: Oct. 10, 2024

Related U.S. Application Data
(63) Continuation-in-part of application No. 18/392,881, filed on Dec. 21, 2023, now abandoned.
(60) Provisional application No. 63/434,415, filed on Dec. 21, 2022.

(51) Int. Cl. G06Q 10/0639

(52) U.S. Cl. CPC G06Q 10/06398

(57) ABSTRACT

A method using a computerized control system developed to gather and store information about the organizational factors that adversely impact people's performance, allowing for proactive correction before human error deviations occur. The system provides a predefined list of factors that describe what people need to optimize their work performance. The predefined list of factors is evaluated by a group of people involved in the process during their daily work routines. These factors are assessed as either positive conditions, indicating factors under control, or negative conditions, representing potential root causes of human errors. The specialized system includes a continuous process workflow that allows the user to identify, visualize, analyze, and correct specific potential root causal factors of human errors by implementing corrective actions to mitigate potential undesired results.

### RELATED APPLICATIONS

This application claims priority from U.S. Provisional Application 63/434,415, filed on Dec. 21, 2022, and is a continuation-in-part application of U.S. Non-Provisional application Ser. No. 18/392,881 filed on Dec. 21, 2023.

### COPYRIGHT NOTICE

A portion of the disclosure of this patent document contains material which is subject to copyright protection. The copyright owner has no objection to the facsimile reproduction by anyone of the patent document or the patent disclosure as it appears in the Patent and Trademark Office patent file records, but otherwise reserves all copyright rights whatsoever. The referenced Copyright registration number is TXu 2-288-758.

### BACKGROUND

Most product quality issues, accidents, and service failures are caused by human errors. As a result, human error can lead to production loss, supply chain disruptions, product recalls, harm to people, environmental damage, among other issues, costing millions annually in any manufacturing industry and elsewhere.

To reduce human errors, common solutions include training and education so that people understand equipment management, processes, and procedures. Providing detailed instructions and standardizing steps through standard operating procedures can help minimize errors. Also, automation plays an important role in reducing human errors as it minimizes human interaction in processes.

For instance, electronic batch records (EBRs) are digital systems used to document and manage the production process prioritizing the replacement of traditional paper records. They reduce human errors by automating data entry and validation, ensuring accuracy and consistency while minimizing documentation errors.

In addition, the previous disclosure U.S. Pat. Pub. No. 20190286462-A1, Systems, Methods, and Media for Presenting Interactive Checklist, improves job performance by helping people avoid human errors caused by incorrect execution of tasks and missed instructions while realizing tasks. It comprises a checklist system that provides customized task lists, emphasizing guidance and step-by-step instructions to ensure efficient task completion.

Also, U.S. Pat. Pub. No. 20020137015-A1, Computer-Aided Method and Apparatus for Assessing an Organizational Process or System, author Lawrence Quinta, includes the evaluation of training standards to ensure that employee training requirements are effective and in compliance with standards. This invention focuses on how well the organization complies with regulated standards associated with organizational processes or systems, in this case how employees comply with regulatory training requirements.

Despite the effectiveness of the above solutions, human errors still occur in the manufacturing industry and other sectors. For example, the training compliance monitoring system offered by Quinta's invention is not sufficient to prevent people from making mistakes. In other words, no matter how effective the training process is and how well the training standard fits the organization's requirements, if the employee is negatively impacted by some negative organizational factor (e.g. excessive working hours), human errors can occur.

While automation significantly contributes to reducing human errors across industries, enhancing quality, efficiency, and reliability in operations, it's essential to acknowledge that not all systems can be automated as many operational processes still rely on human management, increasing the likelihood of human errors.

Once human errors occur, it is common to use the “Define, Measure, Analyze, Improve and Control” (DMAIC) method to define the problem, measure its extent, analyze the data, investigate to determine the root cause, and implement corrective actions. Yet the DMAIC method is a reactive system and not proactive.

None of the above solutions consider what causes people to make mistakes and what people need to do to optimize their job performance to prevent human errors. For example, no matter how effective Bodnick's checklist is in improving job completion by providing step-by-step instructions, if some negative organizational factor adversely impact people's performance during their work routine, the likelihood of human error is active and increases the potential for failures.

The situation is that everyday people interact with multiple organizational factors to complete daily work routines. Just to achieve one task aimed at achieving results, an employee can interact with multiple operational procedures (e.g. ten standard operating procedures), multiple equipment and tools, management decisions, and other organizational factors. Moreover, the people's interactions increase with the number of employees through the organization. Too many interactions with organizational factors coupled with multiple daily changes are prone to provoke complex scenarios for people managing their daily work routine.

Present systems do not provide organizational management with the visibility needed to address this complex scenario. The problem is that employees across all working areas within an organization interact with multiple factors daily, and when a negative factor is present, it is not addressed proactively.

Unfortunately, there is no system or method available for users in the industry to identify factors impacting work performance and document those conditions either ignored or not reported by people. If an organizational factor is impacting an employee's work routine, it is handled manually. However, it's not common for this to occur. The manual process causes limitations in addressing the negative factor condition until it is resolved. Some reported conditions are resolved and most of them are ignored by the organization. Unfortunately, those that are ignored are mitigated after a human error deviation occurs, resulting in significant financial losses and damage to the organization's reputation.

Also, humans tend to be reactive rather than proactive, often implementing corrective actions only after a failure occurs. When a failure happens, an investigation is conducted to identify its root cause. Interviews with those involved often reveal that the issue causing the failure had been impacting their performance for some time, but it was not addressed until it resulted in a costly human error event. For example, those issues that cause human errors can be described as negative organizational factors.

To identify, analyze and correct all the negative factors that impact job performance in all operational areas within an organization, it is desirable to have a computerized system to manage the complex scenario described above. This system should enable all operational areas to participate in the identification of negative factors simultaneously, by providing real-time visibility into the factors impacting people's performance. Furthermore, it's recommended that it includes the development of a dedicated database management system to ensure more reliable multi-user support.

On another note, Excel is capable of performing some database-like tasks, including but not limited to filtering, sorting, basic queries, and others. Nevertheless, it does not qualify as a comprehensive database management system. When it comes to handling advanced database needs such as managing larger datasets, provide reliable multi-user support, ensuring robust data integrity, and executing complex queries, it is more suitable to utilize a dedicated database system like Microsoft Access, SQL Server, or an online database service.

For such reasons, the Human Optimal Work Execution Management-Causal Factor Structure (HOWEM) method and system disclosed in this application was created to manage complex datasets not supported by commonly used computer systems. The HOWEM method considers that human errors can result of negative organizational factors that impact people's work performance leading their actions to deviate from the expected outcome. Such an outcome in turn impacts product quality, causing accidents and service failures. These negative organizational factors should be considered as potential root causes of human errors.

Instead of the reactive solution offered by the DMAIC process, which defines a problem to implement corrective action, the HOWEM system allows people to define the root causes of human errors in order to correct them and avoid potential problems caused by human errors. As a result, the HOWEM method is not designed to define problems but aims to prevent them. Once a human error occur, damage is inflicted as such action is irreversible and costs the organization massive amounts of money. However, it is advisable to have a proactive system to prevent problems.

As a brief description of the HOWEM system, a comprehensive list of factors is provided that define what people need for optimal work execution (e.g., easy-to-clean tools, clear instructions, correct task assignment, positive working climate, adequate working hours, etc.). The computerized system will allow multiple users to evaluate those factors simultaneously. Anything that deviates from that list (e.g., unclear instructions) is evaluated as a negative factor condition, providing the organization with real-time visibility and reliable data about the factors impacting people's performance across all operational areas. Those factors are considered a potential causal factor for human error. This will allow for proactive corrective action to prevent human errors, avoid product issues, accidents and service failures.

HOWEM is the first method focused on the needs of employees, i.e. what they need to optimize their work. As a proactive and continuous control system, the invention is focused on optimizing the interaction of employees with the organizational factors with which they interact to perform their work, including their own personal and physical conditions, to prevent human errors.

### SUMMARY OF THE INVENTION

Instead of being reactive, the present invention, through the system and method, transforms a generic computer into a specialized one that allows users to visualize potential human error root causes and be proactive in mitigating potential future results. The objective is to identify and correct an event's root cause before it occurs, such as fixing a hole in the road before an accident happens.

The method and system are based on the premise that most human errors are the effect of negative organizational factors that affect people's performance, deviating their actions from the expected outcome.

The method and system provide a pre-set list of factors organized in a structured format to define what organizational factors people need to optimize their work performance. These factors are evaluated as positive or negative. Positive Factors are those under control, while negative factors are those that adversely affect work performance and are considered potential root causes of human errors.

Once the evaluation of factors is complete, the computer system automatically generates a report containing all negative factors, including detailed issues, and sends it via email to the relevant organizational areas. This provides real-time visibility into the factors affecting people work performance. The system offers employees an electronic brainstorming board to document recommendations for resolving or correcting negative factors.

The method requires organizational management to support employees in correcting negative factors. For effective corrective actions, the system allows users to share a report containing the negative factors identified, along with details of the implemented corrective action. This promotes knowledge transfer by showcasing successful solutions to areas facing similar issues. For effective corrective actions, the system enables organizational management to generate HOWEM certificate awards to recognize employees who recommended the implemented corrective action.

In summary, the HOWEM method and system promotes employee empowerment by involving them in the control process. They can actively participate by identifying, analyzing, and correcting factors affecting their daily work routines. For instance, negative factors such as hard-to-clean tools can be identified and corrected to avoid a product contamination event. Once negative organizational factors are identified, the system provides visibility into these factors, allowing organizational managers to take actions such as substituting tools for simpler ones to avoid potential related errors. Investing in such solutions to improve people work performance is more cost-effective than dealing with the consequences such as a product contamination event. In conclusion, it is unnecessary to wait for deviations to occur before taking action. People can identify and proactively correct negative organizational factors affecting their daily work routines, preventing human errors and related potential issues and costs.

### BRIEF DESCRIPTION OF THE SEVERAL VIEWS OF THE DRAWINGS

To easily identify the HOWEM system and method and promote the use of its computer system, the following figures were developed to explain how the system communicates and advances:

FIG. 1 illustrates the failure event process and impacts of human error,

FIG. 2 illustrates the HOWEM system database components,

FIG. 3 illustrates HOWEM Methodology and the different steps a task can travel if it represents a negative or a positive Factor,

FIG. 4 illustrates the method data structure used to define in orderly way what affects people's work performance,

FIG. 5 illustrates a list of Factors needed by people to optimize their work performance,

FIG. 6 illustrates the method audit execution process,

FIG. 7 illustrates a computer system workflow of routines to conduct the method continuous optimization process,

FIG. 8 illustrates the data entry form displayed by the computer system to generate an audit record containing a preset list of Factors for evaluation,

FIG. 9 illustrates the data entry form displayed by the computer system to allow users to evaluate the conditions of the preset list of Factors during the audit process,

FIG. 10 illustrates a report the computer system generates to visualize negative Factors identified during the audit process,

FIG. 11 illustrates the data entry form displayed by the computer system containing negative Factors identified during the audit process, allowing a user (e.g., QA) user to either accept the reported negative Factor conditions or cancel it,

FIG. 12 illustrates a report generated by the computer system when the QA user rejects the reported negative Factor conditions and cancels the associated order,

FIG. 13 illustrates the data entry form displayed by the computer system, as an electronic brainstorming board, to allow users to recommend corrective actions to solve negative Factors identified during the audit process,

FIG. 14 illustrates the data entry form displayed by the computer system to allow users document the implemented corrective action details,

FIG. 15 illustrates the data entry form displayed by the computer system to allow users evaluate the implemented corrective action effectiveness,

FIG. 16 illustrates a report generated by the computer system containing the effective corrective actions implemented, allowing users to share it with other areas,

FIG. 17 illustrates a recognition certificate the computer system allows to generate, to recognize people whose recommendations were successfully implemented,

FIG. 18 illustrates examples of graphical images charts, as Key Performance Indicators, to allow users analyze audit evaluation results, Factor conditions trends, corrective actions progress.

FIG. 19 illustrates examples of real-time reports generated by the computer system to allow users analyze audit evaluation results, Factor conditions trends, corrective actions progress,

FIG. 20 illustrates the key principles which comprise the system and method,

FIG. 21 illustrates the key elements of the system and method,

FIG. 22 illustrates a list of the general functionalities of the system and method in the computerized system,

### DETAILED DESCRIPTION OF THE INVENTION

The embodiments described herein present a computer database system for evaluating, gathering, storing, and controlling information about organizational factors that affect people's work performance. It is a continuous control system to optimize the interaction of people with the organizational factors with which they need to interact to perform their work effectively. As a preventive system, it allows people to identify factors adversely impacting their performance, enabling proactive correction to prevent human errors.

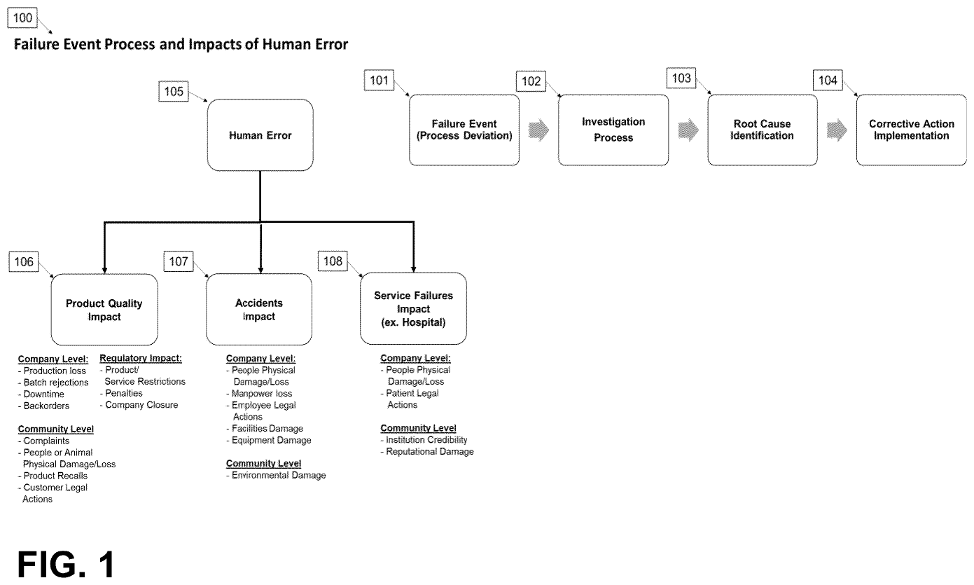

Referring to FIG. 1, describes a failure event process and impacts of human error 100. When a failure event or process deviation happens 101, a comprehensive investigation process 102 is carried out to identify the root cause 103 of the event. Once the root cause is identified, corrective actions 104 are implemented to avoid future recurrences. The method considers as a component that human errors 105 comprise most of the events that cause product quality issues 106, accidents 107, and service failures 108 in all types of industrial processes.

When we consider complex industrial processes, when humans error cause product quality issues 106 can lead to significant expenses, including production loss, batch rejection, downtime, and backorders. At the community level, it has the potential to cause physical harm or death to both people and animals. Additionally, it can result in legal action and complaints from customers, while inciting in recalls of the product. Furthermore, it is worth noting that many of the inadequacies identified by regulatory agencies involve situations where humans fail to ensure the minimum requirements needed to provide assurance that the product meets the required standards of safety, identity, strength, quality, and purity. These failures can cause regulatory impacts such as product or service restrictions, penalties, or even industry closure. Moreover, considering the impact of accidents 107, people may suffer physical harm or loss, resulting in a loss of manpower and/or legal action. Furthermore, equipment and facilities may also be damaged. At the community level, environmental damage may occur, leading to harm to the community. On another note, service failures 108 can have serious consequences too. They can result in physical harm or even death to people or animals and can lead to legal actions by customers against the company.

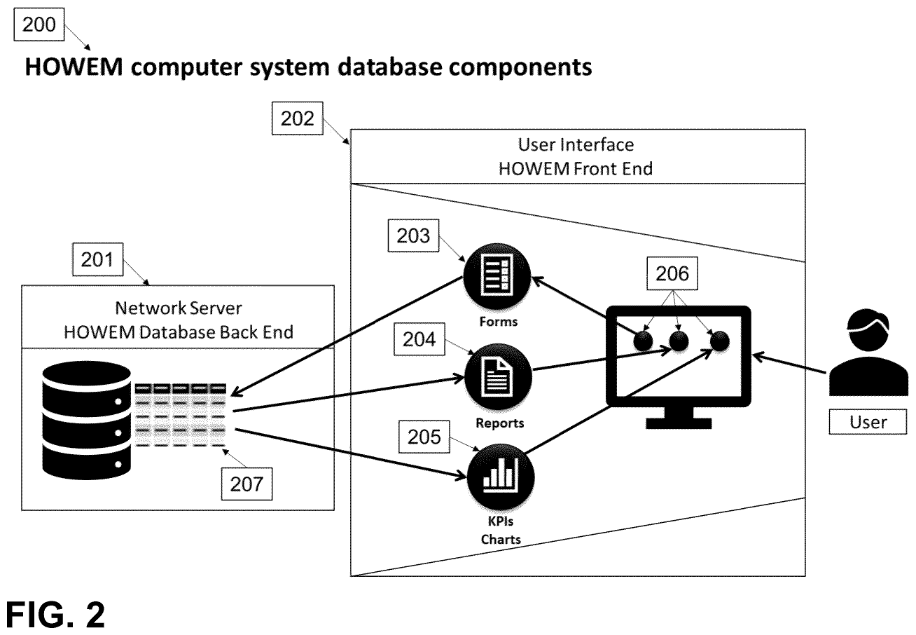

Referring to FIG. 2, it shows the exemplary embodiment of the computer system database components 200. The term “computer system” as used herein refers to the integrated components that collectively enable the execution of computer programs to achieve the objective of this invention. The software computer system comprises a back end 201 and a front end 202, which manage and display all the information stored in the computerized system. The back end 201 is responsible for storing and managing the data, while the front end 202 provide user-friendly interfaces that facilitates interaction with the data stored in the back end.

The backend component 201 of the HOWEM system manages data storage. The data is stored in tables 207, allowing for the retrieval of specific data through filtering and sorting capabilities, ensuring precise data access and management. Moreover, the backend configuration enforces data integrity, ensuring that entered data adheres to predefined criteria. Regarding security measures, the system incorporates a user-level security component, enabling customized access permissions tailored to different user roles. In addition to user-level security, the system offers an encryption feature to safeguard data with customized encryption codes. This capability provides an extra layer of protection against unauthorized data breaches and ensures compliance with stringent data protection regulations.

The front-end component 202 of the HOWEM system is the user interface that allows users to interact with the backend data. It includes three main elements: data entry forms 203, reports 204, and charts (KPIs) 205. The main menu of the HOWEM system is displayed with multiple buttons 206 configured for accessing the different system elements, allowing users to navigate between various parts of the application. By using these buttons 206, the system opens data entry forms 203 that serve as simplified interfaces for entering and editing. Additionally, buttons 206 are configured to open reports 204 and charts 205, which are used for printing or viewing data in a formatted layout.

Data entry forms 203 are linked to the backend tables 207. When users interact with data entry forms 203, they can directly read from, edit, or write to the backend tables 207.

Reports 204 and charts 205 are also linked to backend tables 207. When users interact with these system elements, they can directly read from the backend tables 207. Frontend elements enable users to enter, edit, retrieve, and display data to manage and control all storage data in the system.

The described invention discloses a computer system that provides a continuous control process to identify and visualize specific and potential root causes of human errors, allowing for proactive correction before deviations occur.

By definition, “Human error is an action that has been done but that was not intended by the actor; not desired by a set of rules or an external observer; or that led the task or system outside its acceptable limits”. Wikipedia.

Recognizing that human error is a problem, the HOWEM method focuses on identifying what causes people to deviate from desired outcomes, including working outside acceptable limits such as working excessive working hours. In other words, it seeks to identify the root causes of human errors to correct them and avoid process deviations related to human error. To achieve that, was developed the HOWEM method. The terms “method” or “methodology” as used herein refers to the systematic procedure, continuous control process, and guides developed to achieve the objective of this invention. The systematic procedure includes a series of ordered steps executed in sequence. The control process encompasses a continuous optimization workflow with a series of computer steps using the computer system. The guides consist of instructions and statements.

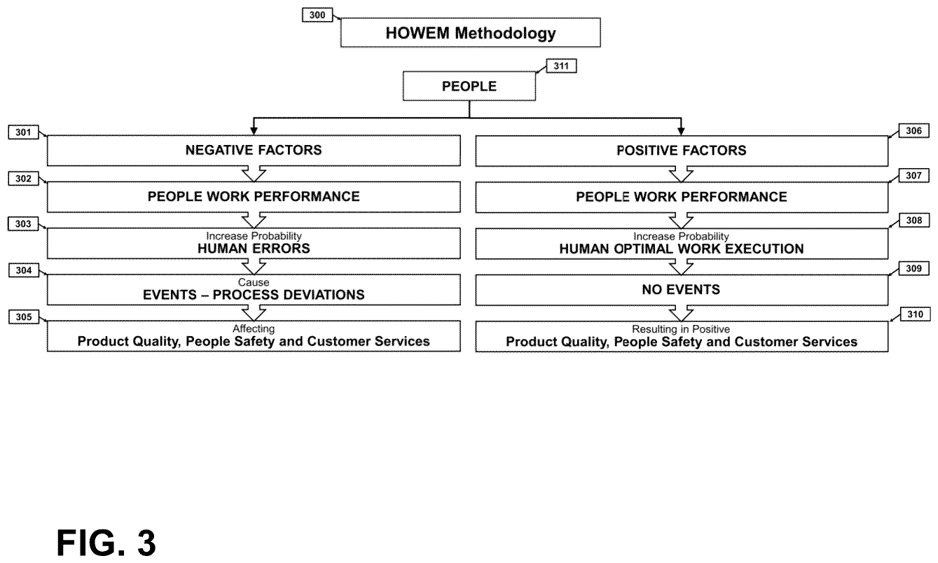

Referring to FIG. 3, the HOWEM methodology 300 states that when negative organizational factors 301 affects people work performance 302, it increases the probability of Human Errors 303 causing events 304 that affect: product quality, people safety and customer services 305, so these negative factors 301 are defined as root cause of human errors 303. On the other side, if positive organizational factors 306, impact people work performance 307, it can increase the probability to optimize their work 308, forecasting the possibility to eliminating future events 309 and promoting the production of high-quality products and services including a safe working environment 310. This explains how the term HOWEM (Human Optimal Work Execution Management) 308 originated. In other words, anything that adversely affects people's performance also adversely affects desired outcomes. If people 311 cause the negative organizational factors 301 that cause events 304, the negative organizational factors 301 are human errors too which can be identified and corrected to prevent undesired results. Based on that, the method focuses on providing people with positive organizational factors 306 so they can optimize their work performance 308, leading to event prevention 309 and the achievement of desired results 310.

The HOWEM method states that a characteristic of a negative organizational factor is that it can remain active for a period, affecting people's performance without causing immediate failures. People can interact with it daily and still achieve the desired work results. This can explain why negative factors are often ignored-when nothing happens, nothing is done. However, a single negative factor can eventually become the root cause of a significant event. Moreover, when a negative organizational factor combines with others, the potential for failure significantly increases.

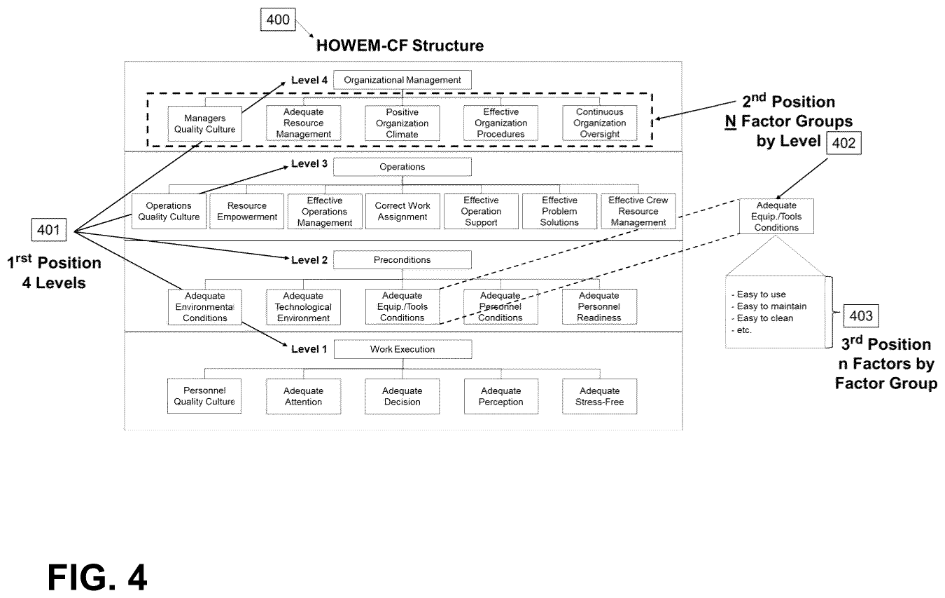

Referring to FIG. 4, within the HOWEM method, was developed a master data structure named as HOWEM-CF Structure (Human Optimal Work Execution Management-Causal Factors Structure) 400. This structure is used to define what people need to optimize their work performance 307, which will help them achieve desired outcomes during their work execution processes 310.

The HOWEM-CF Structure 400 was designed using as a model the HFACS (Human Factors Classification and Analysis System). (Douglas Wiegmann, Ph.D. from the University of Illinois, and Scott A. Shappell, Ph.D. from the Civil Aerospace Medical Institute for the US Navy).

The developed HOWEM-CF Structure 400 is organized into four hierarchical levels 401, with the first position in the structure defining the organizational levels that impact people's work performance:
Level 4—Organizational: This level defines what people need the organization management to provide so they can complete their work effectively.
Level 3—Operations: This level defines what people need the operational areas to provide so they can complete their work effectively.
Level 2—Pre-conditions: This level defines the preconditions that people need so they can complete their work effectively.
Level 1—Work Execution: This level defines what people need to drive their actions towards the desired work results.

The four levels of the master data structure are inherently sequential, with those at the top capable of influencing those below.

In the second position in the structure, for each level 401, the method requires defining all system elements, referred as Factor Groups 402, that people interact with to complete their job. The computer system enables users to create the necessary Factor Groups 402 for each Level 401. So, each Level 401 can contain N (#number of) Factor Groups 402.

In the third position in the structure, for each Factor Group 402, the method requires users to define the necessary attributes (referred to as Factors 403), to enhance their interaction with that system element. The computer system enables users to create the necessary Factors 403 for each Factor Group 402. So, each Factor Group 402 can contain N (#number of) Factors 403.

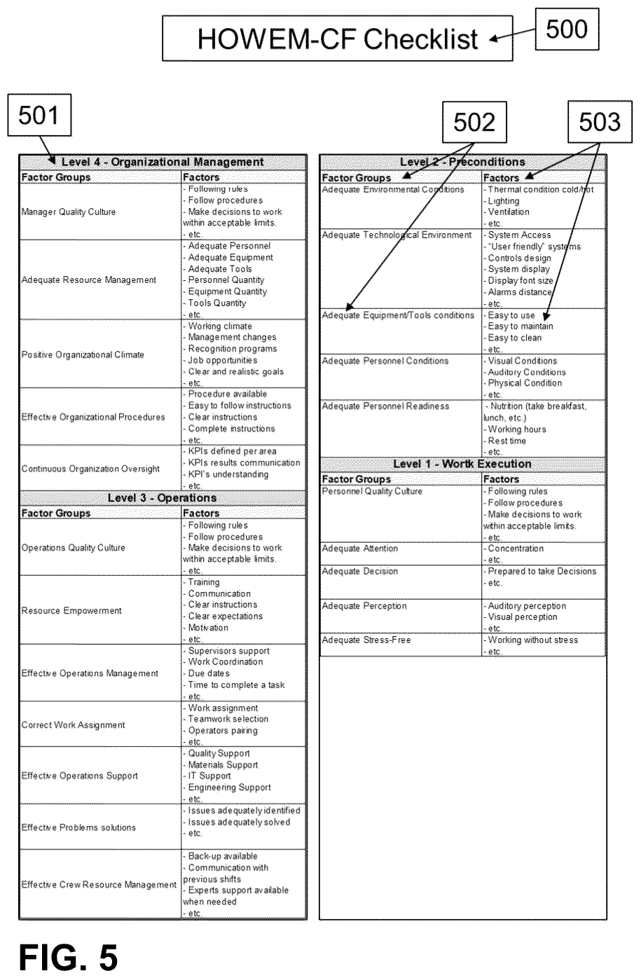

Referring to FIG. 5, by using the HOWEM-CF Structure 400, was developed a predefined list of Factors named as the HOWEM-CF Checklist (HOWEM-Causal Factor Checklist) 500. It is used to define all Factors needed by people to optimize their work performance. The developed HOWEM-CF Checklist 500 is used to visualize all the Factors necessary for enhancing people's daily work routines in a structured format.

The objective is to maintain control over all Factors 503 to support people in optimizing their work performance, thereby enabling them to achieve the desired work results. The HOWEM method defines Factors 503 under control as positive Factors. Conversely, any Factor 503 out of control represents a negative Factor and a potential root cause of human error that needs to be addressed to prevent errors. For instance, at the “Pre-Conditions” level 401/501, people should interact with “Equipment Conditions” 402/502 to perform their work. To enhance interaction with this system element, people need Factors 403/503 such as easy to use, easy to clean, easy to maintain among others. So, the Factors define what people need to optimize their performance and their work execution process.

The initial pre-defined HOWEM-CF Checklist 500 is used as a pre-set master data in the HOWEM computer system. The pre-set master data 500 can be updated according to the user's needs.

The HOWEM computer system was developed to control all Factors 503 outlined in the HOWEM-CF Checklist 500 to ensure that each human interaction with the system elements (defined as Factor Groups) 502, is as effective and efficient as possible. This aims to optimize people's performance during their daily work routines, visualize and proactively correct Factors out of control to prevent human errors, supporting people to achieve the desired outcomes.

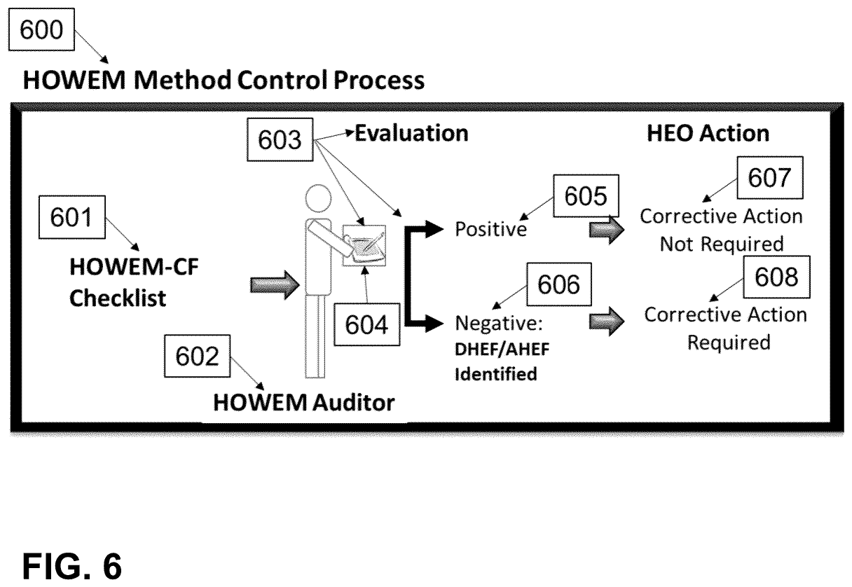

Referring to FIG. 6, it shows the HOWEM audit Execution process. Once the HOWEM-CF Checklist 500 is complete, the HOWEM audit Execution process 600 can be initiated. By using the pre-set master data defined in the HOWEM-CF Checklist 500/601, an auditor or an expert employee of the area 602 will conduct an evaluation 603, considering the Factors conditions as positive or negative. If the organization Factor complies with the objective to enhance work performance, it means that the Factor is under control, it is evaluated as “Positive” 605 and will not require corrective action 607. On the other side, if the organization Factor adversely affects work performance, it means that the Factor is out of control, it is considered a potential root cause of human error that could lead people to deviate from the expected outcome, it is evaluated as a “Negative” Factor 606 and will require corrective action 608. Auditor 602 will comprise of obtaining their peers feedback to complete the audit record documentation (i.e., deficiency description). The computer system allows the identification of negative 606 organizational Factors since the design phase of a new system named Design Human Error Factors (DHEF). If identified during the operational process execution, they comprise the Active Human Error Factors (AHEF). This approach enables the HOWEM method to identify all Factors adversely influencing individuals' performance, offering visibility of potential root causes of human error allowing for proactive correction before deviations occur.

The comprehensive definition of all Factors 503 in the HOWEM-CF Checklist 500 is crucial for identifying any potential negative Factors 606 impacting individuals' performance. Even a single negative Factor 606 can lead to human errors, resulting in undesired outcomes. Incomplete definition of Factors 503 can hamper the organization's ability to detect negative Factors 606. For instance, if in Level 2—Preconditions 401/501, the organization omitted the Factor Group “Adequate Equipment Conditions” 402/502, the evaluation of equipment condition Factors 403/503 will be ignored, leading to undetected negative Factors 606. Consequently, the likelihood of deviations due to ineffective equipment conditions rises. A thorough HOWEM-CF Checklist 500 offers complete visibility within the organization, enabling the detection of negative organizational Factors 606 affecting performance and facilitating the implementation of corrective actions 608 to prevent human errors.

The HOWEM computer system is designed to manage the complexity of capturing in real-time the active negative Factors 606 that adversely affect work performance across all company areas on a daily basis.

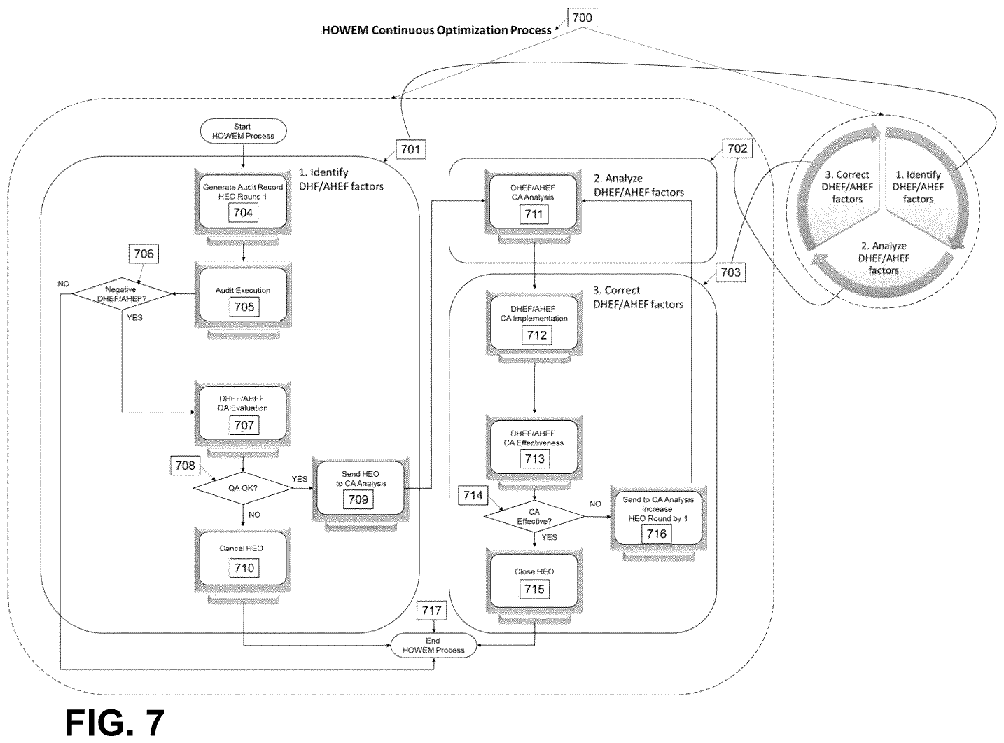

Referring now to FIG. 7, it shows the complete HOWEM continuous optimization process workflow 700, consisting of three main activities configured to be managed by the computer system.
1. Identify DHEF/AHEF Factors, block 701, which includes: Generate Audit Record routine 704, it is configured to allow users (e.g., auditor/assessor), to generate an audit record containing all Factors defined in the HOWEM-CF Checklist 500; Audit Execution routine 705, it is configured to allow users (e.g., auditor/assessor), to evaluate Factor conditions; DHEF/AHEF QA Evaluation routine 707, it is configured to ensure that HOWEM-CF Factor conditions are evaluated against people's performance only. The HOWEM method is not used to manage process deviation or failures. Instead, it is used to identify potential root causes of human error to prevent failures. Routine 708, it is configured to allow users (e.g., quality assurance user), to determine if the Factor evaluation complies with HOWEM methodology 200 and was performed to report a Factor condition adversely affecting people's performance. If the Factor evaluation condition is correct, routine allows the user to continue the HOWEM continuous optimization process workflow and send it to block 702. If the user determines that the Factor evaluation does not comply with HOWEM method, routine 710 allows the user to cancel the HOWEM continuous optimization process workflow 700 and end the HOWEM process 717.
2. Analyze DHEF/AHEF Factors, block 702, which includes: DHEF/AHEF CA Analysis routine 711, it is configured to allow users (e.g., employees) to recommend corrective actions by using an electronic brainstorming board, following block 703.
3. Correct DHEF/AHEF Factors, block 703, which includes: DHEF/AHEF CA Implementation routine 712, it is configured to allow users (e.g., area leaders), to document the implemented corrective action(s) to solve the AHEF/DHEF Factor conditions; DHEF/AHEF CA Effectiveness routine 713, it is configured to allow users (e.g., area leaders), to evaluate the effectiveness of the implemented corrective actions. If the implemented corrective action is effective, routine 714 allows the user to close and finish the HOWEM continuous optimization process workflow 715/717. If the implemented corrective action is not effective, routine 714 allows the users to initiate a new round of analysis to try a new corrective action to solve the Factor condition 716.

Below is a detailed description of the developed method and the computer system's continuous optimization process.

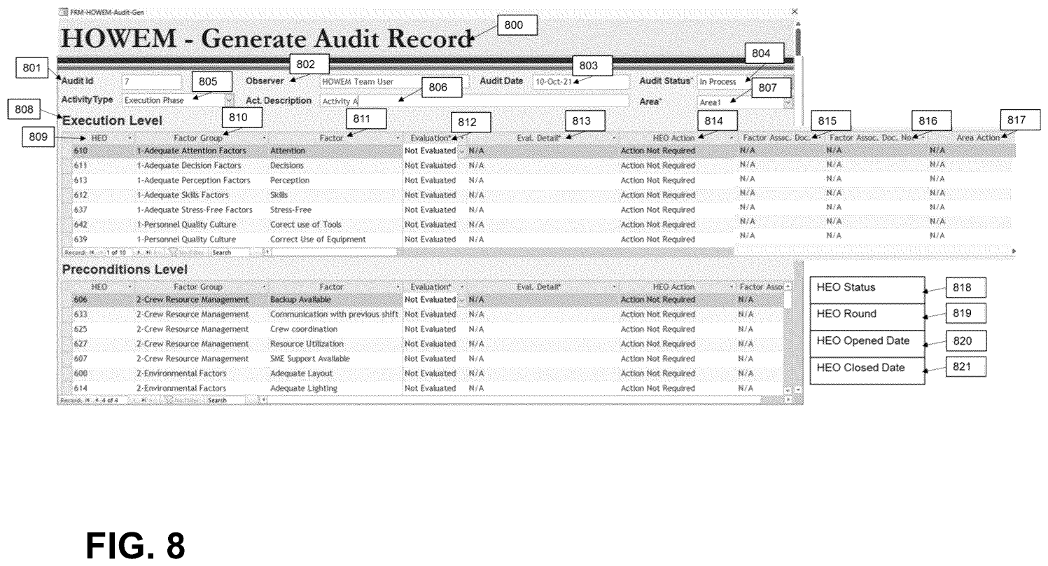

Referring to FIG. 8, to initiate the HOWEM continuous optimization process, the system allows the user to open the interactive user interface: “Generate Audit Record” data entry form 800, routine 704, to create an audit record containing all Factors defined in the HOWEM-CF Checklist 500. First, the auditor should complete the following header fields:
1. Activity Type 805 field is used to specify the phase of the activity to be evaluated during the audit. The user should specify if the audit record is used to analyze the design phase of a new system or an implemented process system during the execution phase.
2. Activity Description 806 field is used to describe the activity to be evaluated during the audit.
3. Area 807 field is used to indicate where the audit process is performed.

Once the auditor completes the above fields, the computer system updates automatically all the remain header fields:
1. Audit Id 801 field is an automatic sequential number.
2. Observer 802 field is populated by the system with the login username.
3. Audit Date 803 field contains the audit current date.
4. Audit Status 804 field is used to specify the status of the audit. The initial default status is “In Process”.

After the header section update, the computer system automatically uploads the pre-set master data containing all the Factors 811/503 with their associate Factor Groups 810/502 and Levels 808/501 defined in HOWEM-CF Checklist 500 to the Audit Record 801. As a result, for each audit record generated in the system, HOWEM generates an evaluation order for each factor defined in the pre-defined list of factors.

For each Factor 811, the computer system automatically populates the following associated data fields:
1. HEO (HOWEM Evaluation Order) 809 field, it is used by the computer system to associate each Factor with a unique tracking order number.
2. Evaluation 812 field, it is used to document the Factor conditions. The predefined fields values are “Positive”, “Negative”, “Not Evaluated” (Default Value), “Not Applicable”. 14
3. Eval. Detail (Evaluation Detail) 813 field, it is used to provides a description of the Factor conditions observed during the audit process, default value is “N/A”.
4. HEO Action 814 field, it is used to indicate the Factor condition's corrective action progress. The pre-defined field values are “Action Not Required” (Default Value), “Corrective Action Required”, “Corrective Actions Analysis”, “Corrective Action Implemented”, “Corrective Action Effective”, “Corrective Action (Not HOWEM)”.
5. Factor Assoc. Doc. 815 (Factor Associated Document) field, it is used to specify the document type associated with the Factor condition if any, (e.g., equipment, procedure, room); default value is “N/A”.
6. Factor Assoc. Doc. No. 816 (Factor Associated Document Number) field, it is used to register the identification number of the Factor Assoc. Doc. (e.g., equipment number, procedure number, room number); default value is “N/A”.
7. Area Action 817 field, it is used to document any immediate action taken to remediate the deficiency associated with the Factor condition: default value “NA”.
8. HEO Status 818 field, it is used to indicate the status of the order (HEO) associated with Factor 811. The pre-defined field values are “Open”, “Cancelled” and “Closed”. 11
9. HEO Round 819 field, it is used to indicate the number of times that a Factor condition is analyzed. The HEO Round increases by one once a Factor order HEO 809 is sent back for additional analysis when the implemented corrective actions are not effective.
10. HEO Opened Date 820 field, it is used to document the Factor condition Evaluation opened date once the HEO status is opened.
11. The HEO Closed Date 821 field, it is used to document the Factor condition closed date once the HEO status is closed.

The HOWEM method states that for each organizational working area, a HOWEM auditor 602 is responsible for the HOWEM continuous optimization process 700. The auditor 602 must periodically perform a five-minute random audit on their peers.

Once the HOWEM Audit Record generation process 704 is completed, the HOWEM audit record 801 is ready to move to routine the 705, Audit Execution process.

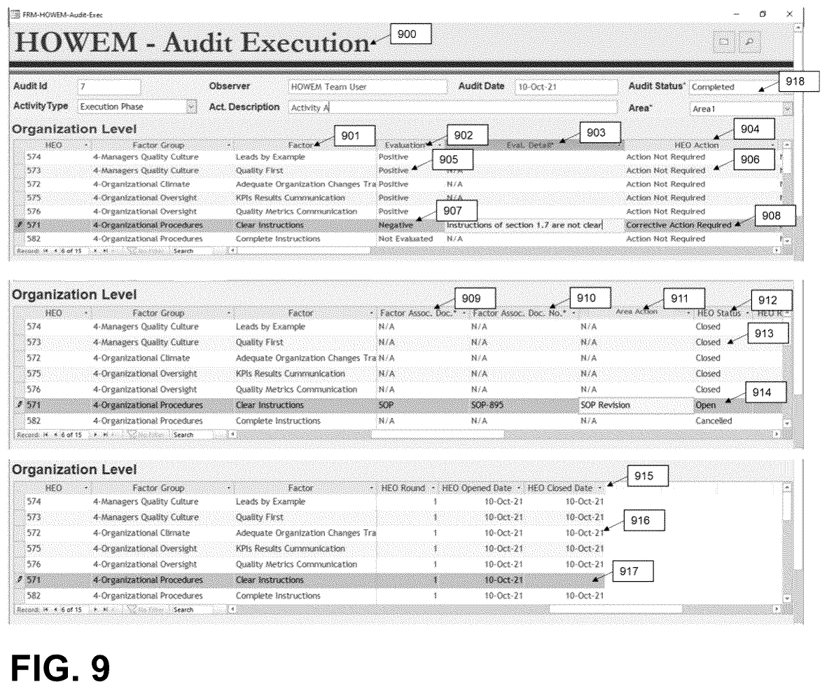

Referring to FIG. 9, to evaluate Factor conditions, the computer system allows the user to open the interactive user interface: “Audit Execution” 900 data entry form, routine 705. During the audit execution process, the auditor should evaluate each Factor as “Positive” 905 or “Negative” 907 filling in the information in the Evaluation field 902. The Audit Execution process 900 is used to identify the negative organizational Factors 907/606 that are affecting people's work performance. It is also used to evaluate positive organizational Factors 905/605 that promote optimal work execution. The auditor should obtain feedback from people working in the audited area to discuss both positive and negative Factor's evaluations. An anonymous process fosters good communication between the auditor and the staff. If Factor 901 is not evaluated or is not applicable to the evaluated activity, it should be updated accordingly (e.g., “Not Evaluated”, “Not Applicable”).

For “Negative” 907/606 evaluations, the computer system updates the HEO Action 904 to “Corrective Action Required” 908/608. The auditor should interview employees about conditions that affect their performance in the area. During this process, the auditor should gather as much information as possible to provide real-time visibility into Factors adversely affecting human performance and potentially leading to errors in the audited area. Then, the auditor should fill in the details that describe the situation using the following fields: Eval. Detail 903, Factor Assoc. Doc. 909, Factor Assoc. Doc. No. 910 and Area Action 911 fields considering the information obtained in the area. For negative Factors 907, HEO Status 912 will remain “Open” 914 and HEO Closed Date 915 will still null 917 until the HEO Status 912 is closed.

For “Positive” 905/605, “Not Evaluated” or “Not Applicable” Factor evaluations the system updates the HEO Action 904 field to “Action Not Required” 906/607.

The HEO Status 912 will be updated to “Closed” 913 automatically and the HEO Closed Date 915 will be updated automatically with the current date and time 916.

The HOWEM computer system provide users to evaluate Factor conditions simultaneously across all working areas.

Once finished, the evaluation of all applicable Factors 901, the auditor should change Audit Status 918 to “Completed”.

If the factor condition evaluation in routine 706 is determined to be “Negative”, the system will proceed to routine 707. In routine 707, a Quality User will assess whether the negative factor condition was evaluated against people's performance. If this is true, the corrective action analysis process 711 will be initiated to address the factor condition issue.

If Factor condition evaluation, routine 706, is evaluates as “Positive” 905/605, “Not Evaluated” or “Not Applicable”, the HOWEM Continuous Optimization process 700 will be concluded 717 as no corrective action will be necessary.

As detailed, each audit record 800 generated within the system prompts the initiation of an order HEO 809 for every Factor 811/503 outlined in the HOWEM-CF Checklist 500. The HOHEM-CF Checklist 500 comprises 71 predefined Factors 503, leading to the generation of 71 HEO orders 809 for each audit record 800. This order framework empowers users to evaluate each of the 71 Factors 503 independently. For instance, in the event that an organization encompasses ten distinct Areas 807, and each Area identifies 5 negative Factors 907/606 during the evaluation process, the system will initiate 50 HEO orders 809 related to these negative organizational Factors 907/6036 within the HOWEM continuous process workflow 700. Each HEO order 809 is autonomously managed within the system through the HOWEM continuous optimization process workflow 700 until its resolution. Upon identification of these negative Factors 907/606 within the organizational areas, the system enables the organization to gain visibility into the 50 negative Factors 907/606 impacting their employees' performance, thereby facilitating proactive corrective measures to mitigate human errors. This underscores the system's capability to provide real-time data on Factors impacting performance, the progression of each order until resolution, trends in negative Factors, and other pertinent statistical insights.

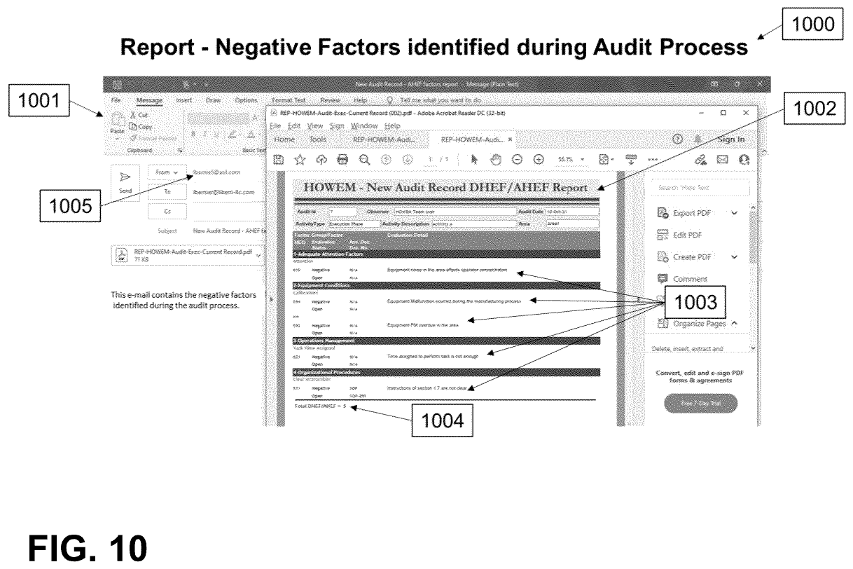

Referring now to FIG. 10, it shows a report containing the negative Factors identified during Audit Process 1000. The computer system allows users to set up email distribution lists including multiple email addresses. Once the Audit Execution process 900 is complete, the HOWEM computer system generates an automatic email 1001 with a report 1002 containing the negative Factors 1003/907 identified during the Audit Execution process 900 including the total quantity 1004 of negative Factors 1003/907 identified. The report 1002 is sent to the people on the predefined distribution list 1005. This report aims to provide users (e.g., organizational managers) with real-time visibility into active negative Factors affecting their people's work performance, enabling them to take action to support the resolution of reported conditions.

The HOWEM method is not designed to document process assessments or deviations that have already occurred (e.g., process regulatory issues, accidents, product deficiencies, or service failures). Instead, HOWEM is designed to identify potential root causes of human errors, focusing on those Factors adversely affecting people's performance in their daily work routines. This aims to visualize potential human error causal Factors to proactively correct them and prevent deviations that could impact product quality, personnel security, or service delivery. For instance, if an auditor mistakenly documents an evaluation unrelated to HOWEM's objectives (e.g., process regulatory issue=room temperature is outside validated process limits), the system allows a QA user (Quality Assurance User) to cancel the order 710, HEO, related to that Factor. Conversely, when a user evaluation aligns with HOWEM objectives (e.g., the room temperature is uncomfortable, too hot in the area), the system permits the QA user to proceed with the HOWEM continuous optimization workflow 702 to address that condition.

After the Audit Execution process 705, all the HEO orders related to the identified negative factors are ready for the next step of the HOWEM 700 Continuous Optimization Process workflow, 707 Quality Control Assessment.

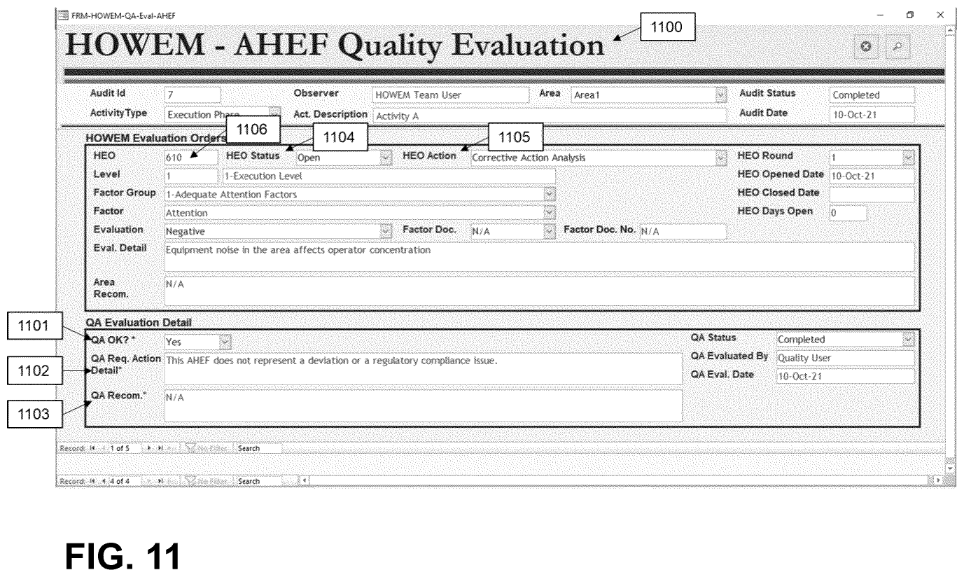

Referring to FIG. 11, shows the evaluation form to assess whether the assessment of factor conditions meets the objectives of HOWEM and ensure that the factor condition was assessed solely based on the performance of individuals. To initiate this process, the computer system allows a QA user to open the interactive user interface: QA Evaluation (Quality Assurance Evaluation) 1100 data entry form, routine 707. It will enable a QA user to evaluate all negative organizational Factors conditions 907 identified during the Audit Execution process 900. The quality assurance user will ensure that those negative Factors conditions 907 complies with HOWEM's objectives. The QA Ok? (Quality Assurance Ok?) field 1101 is used to document if the reported negative Factor condition complies with the HOWEM objectives and is accepted by the QA user. If QA user determines that the identified DHEF/AHEF Factor evaluation complies with HOWEM's objectives, QA OK? field 1101 should be evaluated as “Yes”. The computer system updates the HEO Action 1105 to “Corrective Action Analysis”, which means the HEO 1106 is ready for the next step of the HOWEM continuous process workflow 700, CA Analysis 702/711. If quality user determines that the identified DHEF/AHEF Factor evaluation does not comply with HOWEM's objectives, QA OK? 1101 field should be evaluated as “No”. Then, the computer system automatically updates the HEO Status 1104 field to “Cancelled” and the HEO Action 1105 to “Corrective Action (Not HOWEM)”, meaning the Factor evaluation condition is not aligned with the HOWEM objectives and the associated order HEO 1106, was cancelled 910. Following that, the quality user should update the QA Req. Action Detail 1102 and QA Recom. 1103 fields to describe any required action to address the canceled HEO or any recommendation to solve any negative Factor condition as required. Finally, the HOWEM process is ended 717.

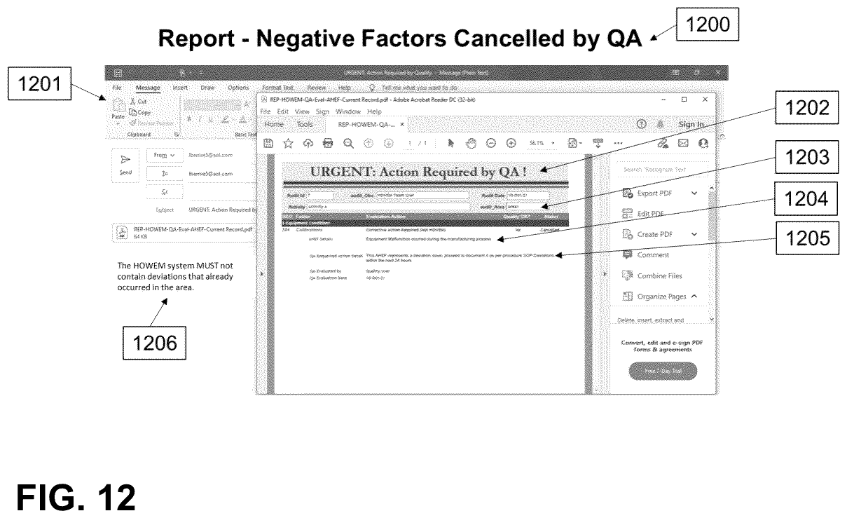

Referring to FIG. 12, it shows a report of a HOWEM evaluation order (HEO) cancelled 1200. Once the HEO order is canceled, the computer system allows the QA user to send an automatic email 1201 with a report 1202 containing the negative Factors 1204 that did not comply with HOWEM objectives as described in the report. Additionally, it includes an explanation of why the order was canceled 1206, the corresponding area 1203, and the required actions 1205 to be taken outside of the HOWEM computer system to resolve the situation.

After the QA Evaluation routine 707, the HEO is ready for the next step of the HOWEM continuous optimization process workflow 700, CA Analysis 711 routine.

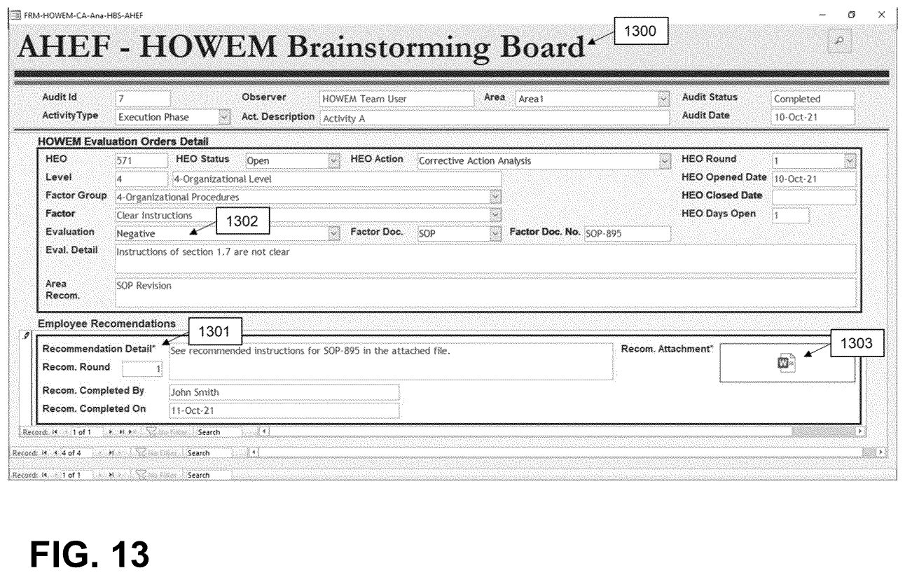

Referring to FIG. 13, to analyze and document recommendations for solving negative Factor conditions, the computer system allows the user to open the interactive user interface: “HOWEM Brainstorming Board” 1300 data entry form. To initiate the analysis process, the auditor 602 should discuss both the positive 605/905 and negative Factors 606/907 with everyone working in the audited area. Positive Factors 905 are discussed to create awareness about the importance of controlling all Factors outlined in the HOWEM-CF Checklist 500. Negative Factors 907 are discussed to inform the team about the issues affecting their performance and to encourage their participation in the resolution process. The HOWEM computer system allows any user to document recommendations 1301 for resolving negative Factor conditions 907/1302, identified during the Audit Execution process 900 by using an electronic HOWEM Brainstorming Board data entry form 1300. Additionally, users can add attachments 1303 to support their recommendations. The HOWEM computer system allows multiple users to enter recommendations for each negative Factor.

After the CA Analysis routine 711, the HEO order is ready for the next step of the HOWEM continuous optimization process workflow 700, CA Implementation routine 712.

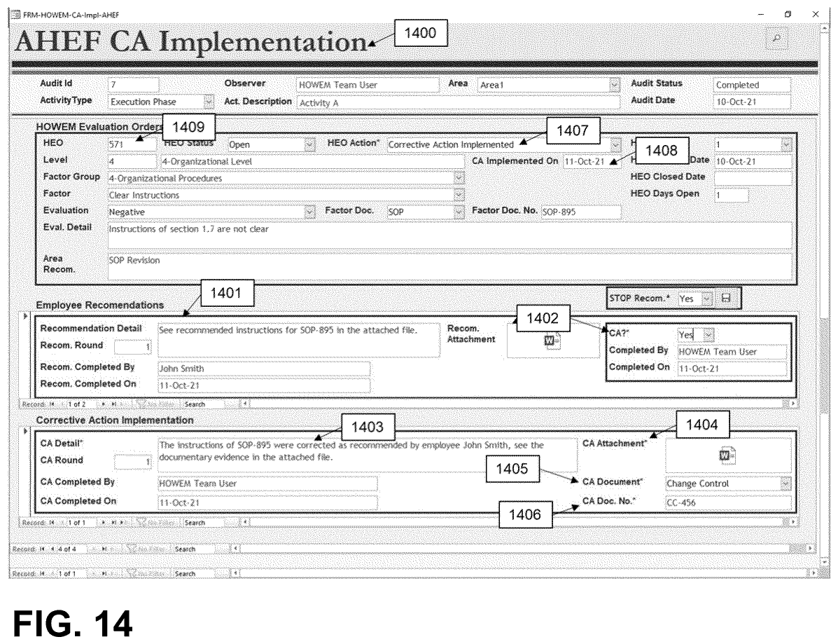

Referring to FIG. 14. To document implemented corrective actions details, the computer system allows the user to open the interactive user interface: “CA Implementation” (Corrective Action Implementation) 1400 data entry form routine 712. After completing the HOWEM Analysis process 1300, employee recommendations 1301/1401 are evaluated to select those to be implemented as part of the corrective action implementation process. The corrective action implementation process is managed outside the HOWEM computer system. Once a corrective action is implemented, the HOWEM computer system allows users to document and store details of the corrective actions implemented. All employee recommendations 1301/1401 that were included in the implemented corrective action are identified in the computer system. If the employee recommendation was implemented, the CA? (Corrective Action?) 1402 field should be marked as “Yes”; otherwise, it should be marked as “No”. Subsequently, all details of the implemented corrective action are documented in the CA Detail (Corrective Action Detail) 1403 field. The computer system provides the option to include document attachments 1404 and any supported document such as CA Document 1405 and CA Document Number 1406 (e.g., Purchase Order, Purchase Order Number), used during the corrective action implementation, when applicable. To complete the process, the HEO Action 1407 should be updated to “Corrective Action Implemented”, then the computer system updates the CA Implemented On 1408 field automatically with the current date and time.

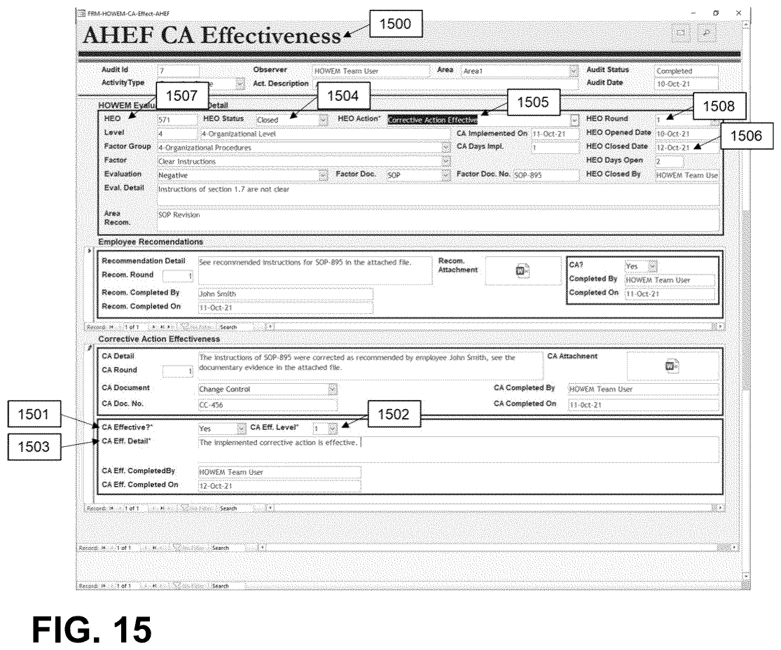

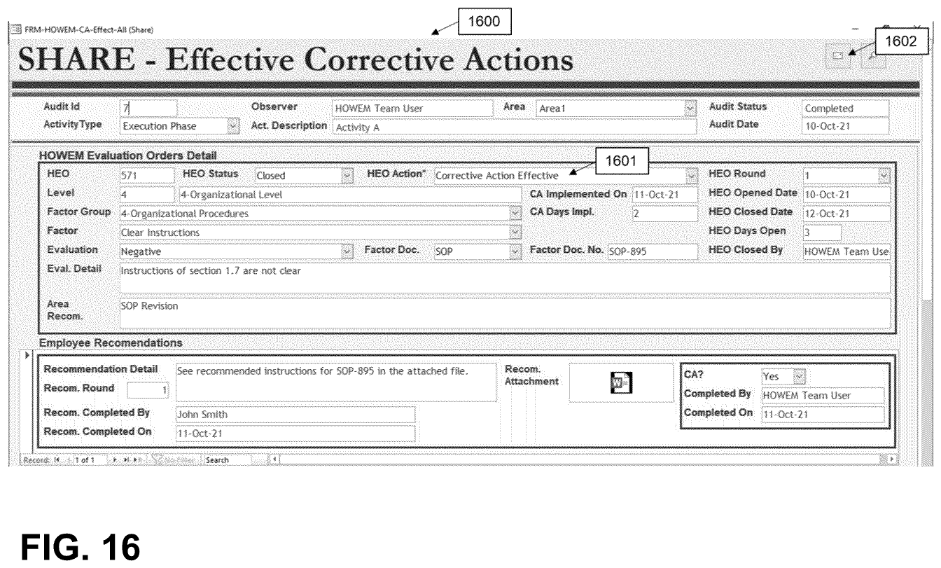

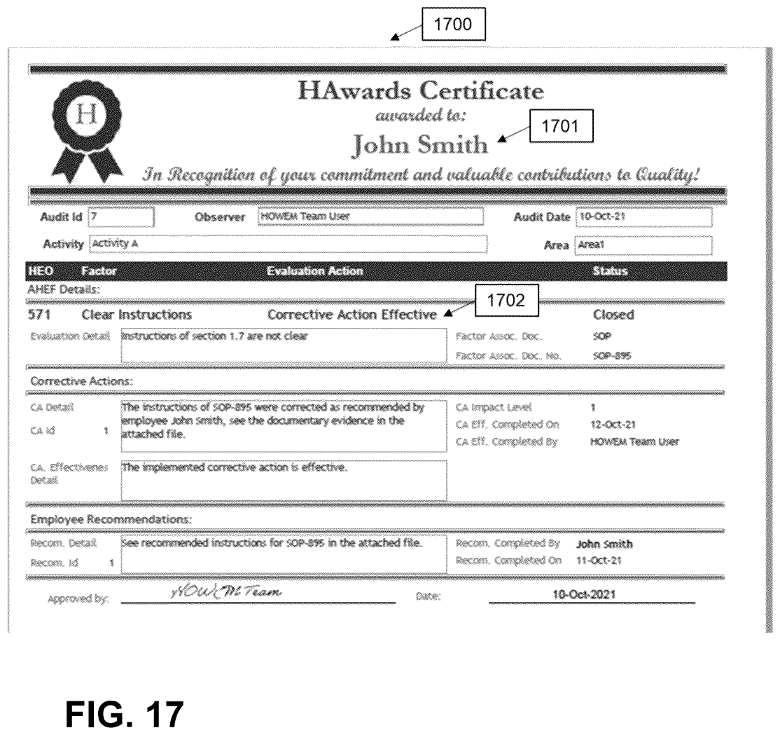

After the CA Implementation routine 712, the HEO order is ready for the next step of the HOWEM continuous optimization process workflow 700, CA Effectiveness routine 713. Referring to FIG. 15, to evaluate and document corrective action effectiveness, the computer system allows the user (e.g., area leader) to open the interactive user interface: “CA Effectiveness” 1500 data entry form, routine 713. The computer system allows the user to define a period to evaluate the corrective action effectiveness once the corrective action is implemented. After a defined period, the computer system enables users to evaluate the effectiveness of the corrective action. When it is determined that the implemented corrective action is effective, the CA Effective? (Corrective Action Effective) field 1501 should be marked as “Yes,”. Then, the computer system updates the HEO Status to “Closed,” and the HEO Close date field 1506 automatically with current date. The computer system enables users to indicate if more than one working area implemented the same corrective action by using the CA Eff. Level (Corrective Action Effectiveness Level) 1502 field. The computer system also enables users to fill in the CA Eff. Detail (Corrective Action Effectivity Detail) 1503 field. It is used to describe the effectiveness detail including the other working areas that also implemented the corrective action. Otherwise, if the corrective action is not effective or if additional corrective actions are required to solve the negative Factor, the CA Effective? (Corrective Action Effective) field 1501 should be marked as “No,”. In this case, the computer system allows users to return 716 the HEO order 1507 for a new Corrective Action Analysis 711/1300. Following, the HEO Evaluation Round 1508 increases by one automatically once the HEO 1507 is sent back 716 for additional analysis, then a new CA Analysis process 711/1300 is initiated to solve the negative Factor; this process is continuous until the negative Factor condition is solved. Referring to FIG. 16, to promote knowledge transfer across the organization working areas, once a corrective action is effective 1601, users can share the implemented corrective actions to promote knowledge transfer with other areas within the organization that May have similar negative Factor conditions affecting their people. The computer system allows users to share 1602 a report 1600 with the details of the implemented corrective action. Referring now to FIG. 17, the computer system enables organization managers to generate a recognition certificate called HAwards (HOWEM Award) Certificate 1700 to recognize employees 1701 who contributed to the HOWEM brainstorming process, and whose recommendations were effectively implemented 1702.

The identification of negative Factors conditions through a direct interaction with people during their daily work routines provides a reliable and measurable information about the Factor conditions that adversely affect people work performance across all the organizational areas.

The HOWEM computer system automatically stores all gathered information documented in the data entry forms 203 described in the HOWEM method continuous control process workflow 700 in the backend tables 207.

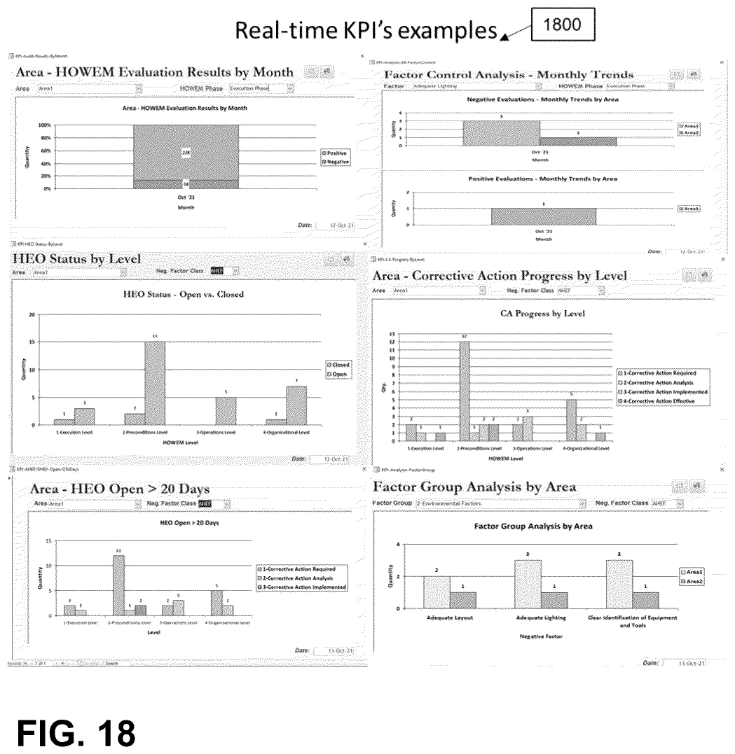

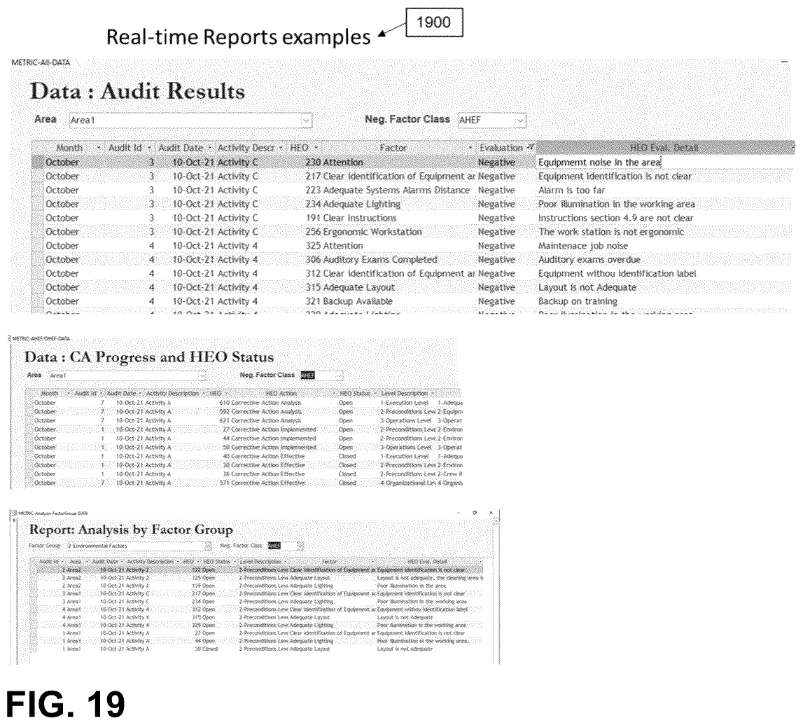

Referring to FIG. 18 and FIG. 19, the computer system enables users to view all information stored in the back-end tables 207. The data can be retrieved via predefined graphical images as Key Performance Indicators (KPIs) 205/1800 or reports 204/1900, allowing users to analyze positive conditions within the working areas and daily Factor conditions that adversely affect people's work performance.

Real-time Key Performance Indicators (KPIs) 1800 and reports 1900 are integral to this method, offering up-to-date insights into the status of negative Factor conditions. Whenever data changes, KPIs 1800 and reports 1900 are automatically updated to reflect the latest information. This real-time monitoring capability enables users to keep track of reported negative Factor conditions as they occur, ensuring immediate visibility of issues that could affect employee performance across the organization.

From the identification of a negative Factor to its resolution, users can track the entire corrective action process. The computer system enables any user to open KPIs 1800 and reports 1900 to view evaluation results, Factor condition trends, and progress of corrective actions, providing a comprehensive understanding of negative Factors across all working areas and how they are being addressed. The computer system also calculates the duration that negative Factors remain open, allowing users to identify unaddressed issues in their working areas.

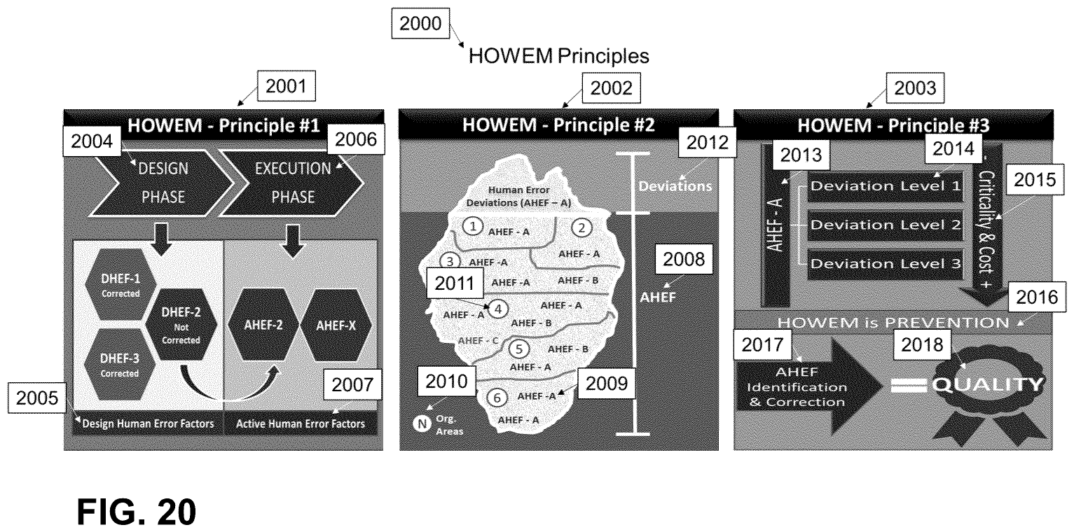

Referring now to FIG. 20, the HOWEM method is based on three principles 2000. The first principle, 2001, starts during the design phase 2004 of a new system (e.g., new process, new equipment, new manufacturing room). When a design human error Factor (DHEF) 2005 is not identified and corrected during the design phase 2004, it will provoke an active human error Factor (AHEF) 2007 at the execution phase 2006 once implemented. The system and method included herein seeks to preempt such potential results at the design phase.

Following this principle, if an organization needs to provide a new tool to a manufacturing area and uses the HOWEM method to evaluate it, they can identify any negative Factors associated with the tool before purchasing it, ensuring its adequacy for enhancing work performance. Conversely, if the organization provides people a tool that negatively impacts their work performance (e.g., a tool that is difficult to clean), this decision increases the potential for people to fail the cleaning process, leading to contamination and product quality issues. This means that if negative Factors are not addressed in the design phase before implementing/installing/buying the system, the potential for failures will increase once the system is in production or service.

The second principle 2002 states that when an active human error Factor (AHEF) 2008 is identified in an organizational area 2010 during the HOWEM audit execution process 705, 900, the same AHEF-A Factor 2009 could be found in the same area 2011 and other areas 2010 (e.g., areas 1, 2, 3, 4, 5, 6) within the organization. This increases the potential for deviations 2012 due to that AHEF-A Factor 2009.

Following this principle, when an employee reports an issue, it's possible that other employees are facing the same problem. For example, if an employee reports misunderstanding new safety equipment and states that it is difficult to use because they don't understand its operation, this could indicate that other employees in different areas might also be struggling. This increases the risk of accidents due to improper use of the safety equipment. In this specific case, the auditor should clarify the correct usage of the equipment to the employee. This ensures that the employee comprehends and can effectively utilize the equipment. The auditor should then document this action, Area Action 911, in the system. These documented actions should be analyzed to identify common issues. If necessary, a detailed explanation of the correct usage of the safety equipment should be provided to all employees who interact with it within the organization. Furthermore, comprehensive training on this specific equipment can help prevent human errors and accidents associated with its use.

The third principle 2003 considers how the probability of a process deviation due to a human error decrease if proactive actions are taken prior to its happening. The HOWEM method states that the AHEF Factors are like potholes in the street. If a pothole is not fixed, it can cause an accident at any time with varying levels of severity and cost. When the pothole is repaired and eliminated, any potential accident related to that specific problem on the road is also eliminated. The same occurs with an AHEF Factor 2013, it can cause a deviation at any time at different levels 2014 increasing the criticality and cost 2015 by level 2014. HOWEM is prevention 2016, any AHEF 2017 should be identified and corrected to prevent deviations and obtain a quality outcome 2018.

Following this principle, when an employee reports an issue related to a Factor that affects their concentration (e.g., a construction project causing noise during working hours), this negative Factor could impact multiple employees and lead to multiple errors with associated costs. Once the negative Factor is addressed, such as rescheduling the construction project to non-working hours, all potential issues are eliminated. This is how HOWEM aims to prevent human errors, thereby avoiding product quality issues, accidents, or service failures.

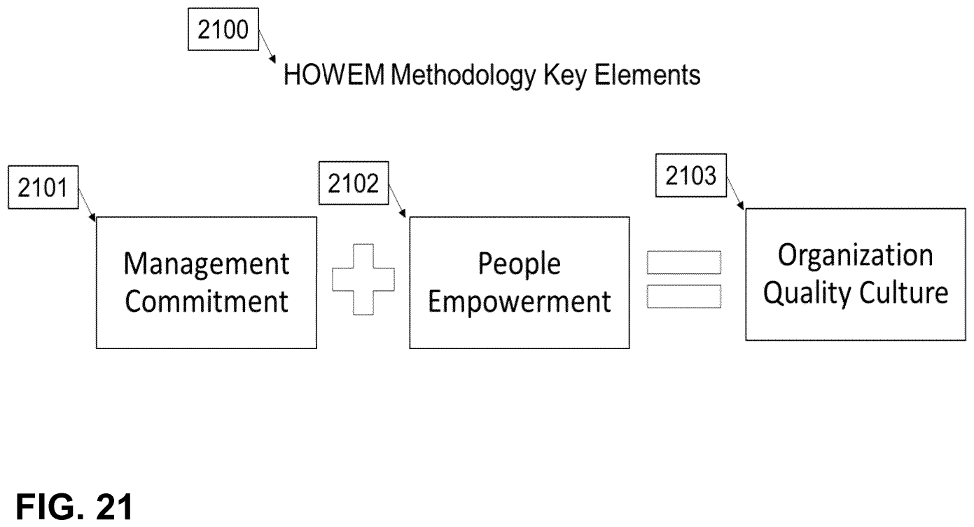

In FIG. 21, the key elements comprising the HOWEM system and method are depicted. The HOWEM method introduces a new organizational culture. It integrates management personnel with manufacturing employees for continual improvement, focusing on what people need to optimize their work performance, as defined in the HOWEM-CF Checklist 500. The first key element of HOWEM is management commitment 2101. Management commitment is fundamental to creating a quality culture within the organization. Management must provide the required organizational Factors to help employees enhance their performance. It also refers to the commitment of organization managers to support their employees in the HOWEM control process. Managers should support their employees in resolving any Factors affecting their daily work routine, enabling them to achieve the organization's desired outcomes. To support this, the HOWEM computer system is designed to provide real-time visibility of any active negative Factor from the moment it is identified until it is resolved, as shown in the HOWEM continuous optimization process 700.

In addition, block 2102 comprises of people empowerment. Organization managers committed to employee empowerment recognize their employees' experience, education, and skills as the most important assets of their organization. The HOWEM method involves employees in identifying Factors affecting their daily work routine and promotes their participation in correcting them by using the HOWEM Brainstorming Board data entry form. This recognition and involvement motivate employees to maintain control over the Factors affecting their performance, resulting in increased productivity.

Both block 2101 and 2102, will result in an organization quality culture 2103, the third HOWEM Key element. The HOWEM-CF Checklist 500 defines what needs to be controlled and the HOWEM continuous optimization process 700, establishes how to control it. The definition of the HOWEM-CF checklist 500 will provide the organization with a physically tangible and specific list of Factors that describe what employees need to optimize their performance. Thus, both organization managers and employees will know what needs to be controlled to optimize work performance and achieve the desired outcomes. To support this, the HOWEM continuous optimization process 700 defines how management and employees must collaborate to continuously identify and visualize Factors that are out of control, enabling proactive corrections to prevent human errors.

The primary objective of the HOWEM method is to develop a robust quality culture 2103 that addresses the operational needs of employees, thereby preventing deviations caused by human error. HOWEM's quality culture 2103 demands discipline; everyone must know, understand, and take appropriate actions to control the Factors outlined in the HOWEM-CF Checklist 500. This is how the HOWEM method supports the organization in promoting optimal work execution, resulting in quality products, ensuring people's safety, and delivering quality services.

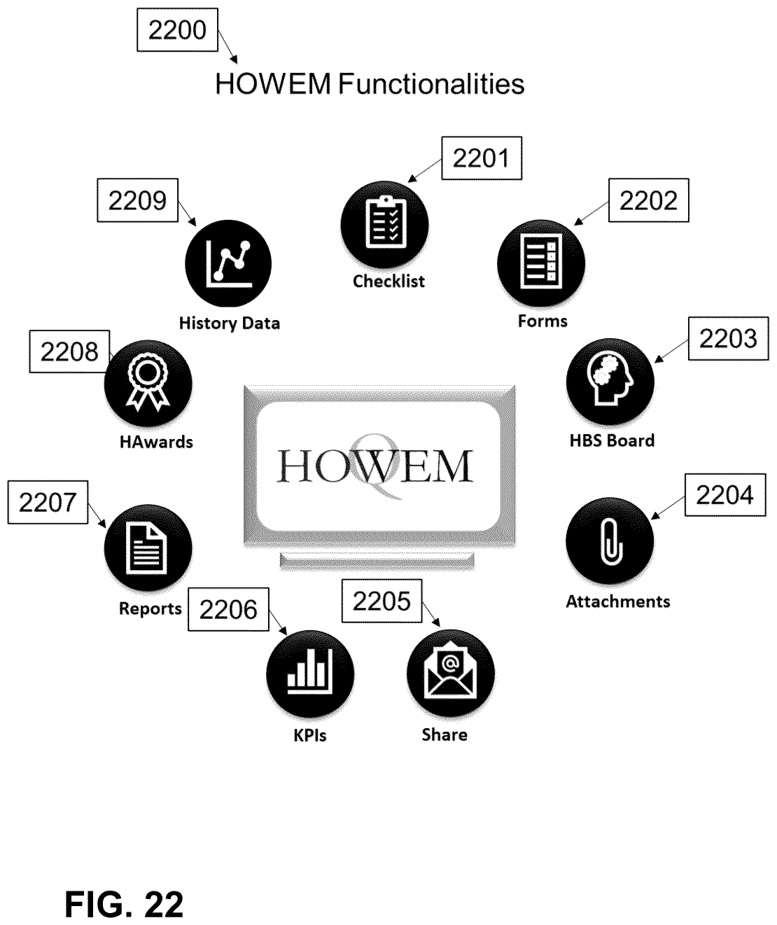

Referring to FIG. 22, the embodiment of the HOWEM system, as summarized below, illustrates its integration of multiple HOWEM functionalities 2200 to support the HOWEM method outlined in this document. It shows the comprehensive capabilities provided by the system and method within the computerized environment. These include: enabling users to create customized HOWEM-CF Checklist 2201/500 to identify essential Factors for optimizing work performance; utilizing data entry forms 2202/203/800/900/1100/1300/1400/1500 to document and store all required data within the HOWEM continuous optimization process 700; integrating a HOWEM Brain storming Board (HBS Board) function 2203/1300 to foster participation by soliciting corrective action recommendations during the CA Analysis process 711/1300; providing attachment functions 2204/1303 for adding documents to Corrective Action Analysis (HOWEM Brain storming Board) and Corrective Action Implementation 1400 data entry forms 203; offering Share functions 2205/1600 to facilitate knowledge transfer via automatic reports that detail effective corrective actions implemented; providing real-time visibility with tangible data by updating KPIs 2206/205/1800 and Reports 2207/204/1900 to analyze data results, trends, corrective action statuses, and progress related to DHEF/AHEF Factors conditions; and generating HAwards Certificates 2208/1700 (HOWEM Awards Certificates) to acknowledge employee recommendations successfully implemented. Most importantly, all data gathered during the HOWEM continuous optimization process 700 is stored in the backend tables 207, maintaining a complete history of data 2209 documented in the computer system.

Modifications to the described computer stem and method can be made without straying from the essence and scope of the invention as outlined in the following claims.

What is claimed is:

1. A computerized method for work execution management using causal factor structure, comprising:
a. Providing a pre-set master data structure;
b. Organizing the pre-set master data structure into four (4) hierarchical levels to define the organizational levels impacting people work performance;
c. Defining a Factor Group comprising a plurality of system elements that people interact with to complete their work associated for each hierarchical level;
d. Defining the optimal attributes of each system element needed to enhance people's performance;
e. Importing a preset list of factors in a checklist comprising a standard list of factors needed by people to optimize people's work performance;
f. Providing the checklist as a physical and tangible list of factors, aiming to visualize what factors are needed to optimize people's work performance;
g. Establishing a plurality of positive factor conditions, wherein the positive factor conditions have a positive impact on people's work performance;
h. Establishing a plurality negative factor conditions, wherein the negative factor conditions have a negative impact on people's work performance factor that is out of control and a potential root cause of human error.
i. Establishing that a positive factor condition does not require corrective action;
j. Establishing that a negative factor condition requires corrective action;
k. Establishing that correcting a negative factor condition changes it from a negative factor condition to a positive factor condition.
l. Establishing that describing a negative factor condition defines a specific root cause of human error;
m. Establishing that correcting a specific root cause of human error prevents its specific potential human error; and
n. Enabling modifications to the checklist by adding, editing or deleting.

2. The method of claim 1, further comprising:
i. Displaying in a displaying device the checklist;
ii. Identifying each factor with a unique identifier number, referred to as an evaluation order;
iii. Prompting an assessor for evaluating factor conditions during the design process of a new system;
iv. Prompting the assessor to evaluate factor conditions during any people-working execution process;
v. Prompting an assessor for evaluating factor conditions in a predefined working area;
vi. Prompting an assessor to identify positive factor conditions;
vii. Prompting an assessor to identify negative factor conditions;
viii. Enabling an assessor to identify factor conditions as “Not Applicable” or “Not Evaluated”;
ix. Storing negative Factors identified during the design process as design human error factor;
x. Storing negative factors identified during the execution process as active human error factor;
xi. Setting the date and time for each factor condition documented in the system;
xii. Allowing a user to document the negative factor conditions details;
xiii. Allowing a user to document specific details associated with the factor group;
xiv. Allowing the assessor to document any remedial actions taken to address the factor condition;
xv. Storing factor condition results including all documented information;
xvi. Generating an automatic report containing all documented negative factor conditions; and
xvii. Enabling managers to visualize the negative factor conditions affecting their people across organizational working areas.

3. The method of claim 2, further comprising:
i. Setting up an email distribution list containing working area leaders; and
ii. Sending an automatic email to the distribution list containing the automatic report.

4. The method of claim 3, further comprising:
a. Allowing people to retrieve data in the pre-set master data structure through filtering and sorting;
b. Wherein the data comprises factor conditions, evaluation results, trends, corrective actions status, and progress;
c. Allowing visibility of factor condition order statuses by area, showing the quantity of open versus closed negative factors per working area;
d. Comparing how the same factor condition is evaluated in different organizational areas to analyze factor conditions trends;
e. Allowing users to define the time in days required to resolve a negative factor condition and the time to evaluate the effectiveness of an implemented corrective action;
f. Calculating the duration a negative factor remains open, allowing users to visualize unaddressed negative factor conditions per level, factor group or working area;
g. Calculating the time taken to evaluate the effectiveness of implemented corrective actions;

5. A computerized system for work execution management using causal factor structure, comprising:
a. One or more processors;
b. Memory storing program instructions executable by the one or more processors to perform the steps of:
c. Providing a pre-set master data structure;
d. Organizing the pre-set master data structure into four (4) hierarchical levels to define the organizational levels impacting people work performance;
e. Defining a Factor Group comprising a plurality of system elements that people interact with to complete their work associated for each hierarchical level;
f. Defining the optimal attributes of each system element needed to enhance people's performance;
g. Importing a preset list of factors in a checklist comprising a standard list of factors needed by people to optimize people's work performance;
h. Providing the checklist as a physical and tangible list of factors, aiming to visualize what factors are needed to optimize people's work performance;
i. Establishing a plurality of positive factor conditions, wherein the positive factor conditions have a positive impact on people's work performance;
j. Establishing a plurality negative factor conditions, wherein the negative factor conditions have a negative impact on people's work performance factor that is out of control and a potential root cause of human error.
k. Establishing that a positive factor condition does not require corrective action;
l. Establishing that a negative factor condition requires corrective action;
m. Establishing that correcting a negative factor condition changes it from a negative factor condition to a positive factor condition.
n. Establishing that describing a negative factor condition defines a specific root cause of human error;
o. Establishing that correcting a specific root cause of human error prevents its specific potential human error; and
p. Enabling modifications to the checklist by adding, editing or deleting.
